(19) United States
(12) Patent Application Publication
(10) Pub. No.: US 2026/0184248 A1
(43) Pub. Date: Jul. 2, 2026

(54) SEAT STRUCTURE

(71) Applicant: Honda Motor Co., Ltd., Tokyo (JP)

(72) Inventors: Manabu MATSUMOTO, Tokyo (JP); Yushiro TACHIBANA, Tokyo (JP)

(73) Assignee: Honda Motor Co., Ltd., Tokyo (JP)

(21) Appl. No.: 19/333,394

(22) Filed: Sep. 19, 2025

(30) Foreign Application Priority Data
Dec. 26, 2024 (CN) 202411931424.X

(51) Int. Cl. B60N 2/68; B60N 2/58; B60N 2/64; B60R 11/02; B60R 22/18; B60R 22/26

(52) U.S. Cl. CPC B60N 2/688; B60N 2/58; B60N 2/64; B60R 11/0217; B60R 22/26; B60R 2022/1831

(57) ABSTRACT

A seat structure capable of improving an acoustic performance of a speaker and maintaining a usability of a seatbelt webbing, thereby enhancing operability. The seat structure includes: a seat, including a seat back; a speaker, disposed inside the seat back and facing forward of the seat back; a webbing outlet guide, disposed above the speaker and at least partially overlapping a sound emitting portion of the speaker in a width direction; a seatbelt webbing, passing through the webbing outlet guide and extending downward along a front surface of the seat back; and a restricting member, disposed on a surface of the seat back. The restricting member has a restricting portion that at least restricts a position of the seatbelt webbing in the width direction, and the restricting portion restricts at least a portion of the seatbelt webbing from overlapping the sound emitting portion of the speaker in the width direction.

### CROSS-REFERENCE TO RELATED APPLICATION

This application claims the priority benefit of China application serial no. 202411931424.X, filed on Dec. 26, 2024. The entirety of the above-mentioned patent application is hereby incorporated by reference herein and made a part of this specification.

### BACKGROUND

### Technical Field

The disclosure relates to a seat structure, and more particularly to a seat structure provided with a speaker and a seat belt.

### Description of Related Art

In recent years, efforts to provide access to a sustainable transportation system that also considers people in vulnerable positions among traffic participants, such as the elderly, persons with disabilities, or children, are becoming more active. In order to achieve the above purpose, research and development are being conducted to further improve transportation safety and convenience through development related to enhancing operability. However, in the development related to enhancing operability, the operability of a seat structure mounted on a vehicle is an issue.

In the prior art, a seat structure mounted on a vehicle can be provided with a seat belt, and when a passenger sits on the seat, safety protection can be performed by surrounding the body with the seat belt. Typically, a webbing as a seat belt main body installed through a retractor is provided inside a seat back of the seat, and an outlet opening is provided at an upper portion of the seat back so that the seatbelt webbing can be drawn out through the outlet opening. In addition, a seat structure mounted on a vehicle can be provided with a speaker, and when a passenger sits on the seat, auditory entertainment (e.g., playing music) can be enjoyed or notifications (e.g., playing warning sounds) can be received through the speaker. Typically, a speaker is provided inside the seat back, and the speaker emits sound to the outside through a speaker grille. However, in such a seat structure, when the seatbelt webbing is not in use, the seatbelt webbing hangs downward from the outlet opening and may block a sound emission area of the speaker, thereby reducing an acoustic performance of the speaker. Furthermore, if the seat belt is installed at a position farther from the speaker and at an upper portion of the seat back in order to avoid the sound emission area of the speaker, a usability of the seat belt is reduced.

The disclosure is intended to solve the above issue and aims to improve the operability of the seat structure. Furthermore, transportation safety is further improved, contributing to the development of a sustainable transportation system.

### SUMMARY

The disclosure provides a seat structure that is capable of improving an acoustic performance of a speaker and maintaining a usability of a seatbelt webbing, thereby enhancing an operability.

The disclosure provides a seat structure, including: a seat, including a seat back; a speaker, disposed inside the seat back and facing forward of the seat back; a webbing outlet guide, disposed above the speaker and at least partially overlapping a sound emitting portion of the speaker in a width direction of the seat back; a seatbelt webbing, passing through the webbing outlet guide and extending downward along a front surface of the seat back; and a restricting member, disposed on a surface of the seat back. The restricting member has a restricting portion that at least restricts a position of the seatbelt webbing in the width direction, and the restricting portion restricts at least a portion of the seatbelt webbing from overlapping the sound emitting portion of the speaker in the width direction.

In an embodiment of the disclosure, the restricting portion is, in the width direction, located between a central portion and a peripheral portion of the sound emitting portion.

In an embodiment of the disclosure, the restricting portion is located between the sound emitting portion and the webbing outlet guide.

In an embodiment of the disclosure, the seat further includes a headrest disposed on the seat back, the speaker and the webbing outlet guide are, in the width direction, located on at least one side relative to a center of the headrest, and the restricting portion is, in the width direction, located at a position farther from the center of the headrest than a central portion of the sound emitting portion.

In an embodiment of the disclosure, the restricting member has flexibility and includes: a base portion, extending forward and upward along the surface of the seat back; and an extended portion, extending from an upper end of the base portion outward in the width direction relative to a central portion of the sound emitting portion, and the restricting portion is formed by an end portion of the base portion corresponding to the extended portion.

In an embodiment of the disclosure, the seat further includes a skin member that forms the surface by covering the seat back, and a speaker grille that covers the speaker from a front side of the skin member, the restricting member has a stitched portion stitched to the skin member, and the stitched portion is located at a portion of the skin member covered by the speaker grille.

In an embodiment of the disclosure, the restricting member has a flange portion extending along the skin member, and the stitched portion is disposed on the flange portion.

In an embodiment of the disclosure, the skin member has an opening portion located at a portion facing the sound emitting portion, the seat further includes a reinforcing member located at a periphery of the opening portion and fixed to the skin member, and the restricting member and the reinforcing member are stitched together to the skin member.

In an embodiment of the disclosure, the seat further includes an interior decorative member fixed to the seat back and disposed closer to an inner side of the seat back than to the skin member, and the stitched portion is located between the speaker grille and the interior decorative member.

The seat further includes an interior decorative member fixed to the seat back and disposed closer to an inner side of the seat back than to the skin member, and the stitched portion is located between the speaker grille and the interior decorative member.

Based on the above, in the seat structure of the disclosure, the restricting member is located on a surface of the seat back, and therefore the restricting member can be easily provided to restrict a position of the seatbelt webbing without changing an original configuration of the seat structure. Furthermore, even when at least a portion of the webbing outlet guide overlaps the sound emitting portion of the speaker in the width direction such that the webbing outlet guide and the speaker are tightly arranged, the restricting member can restrict at least a portion of the seatbelt webbing from overlapping the sound emitting portion of the speaker in the width direction through the restricting portion, thereby preventing an entire region of the seatbelt webbing drawn out from the webbing outlet guide from covering the sound emitting portion of the speaker. Accordingly, the seat structure of the disclosure is capable of improving an acoustic performance of the speaker and maintaining a usability of the seatbelt webbing, thereby enhancing operability.

To make the features and advantages of the disclosure more comprehensible, several embodiments accompanied with drawings are described in detail as follows.

### BRIEF DESCRIPTION OF THE DRAWINGS

FIG. 1 is a partial schematic view of a seat structure according to an embodiment of the disclosure.

FIG. 2 is a partially enlarged schematic view around a restricting member of the seat structure shown in FIG. 1.

FIG. 3 is a schematic cross-sectional view along a tangent line I-I′ around the restricting member of the seat structure shown in FIG. 2.

FIG. 4 is a partial schematic view of the seat structure shown in FIG. 1 in a state in which a speaker grille is removed.

### DESCRIPTION OF THE EMBODIMENTS

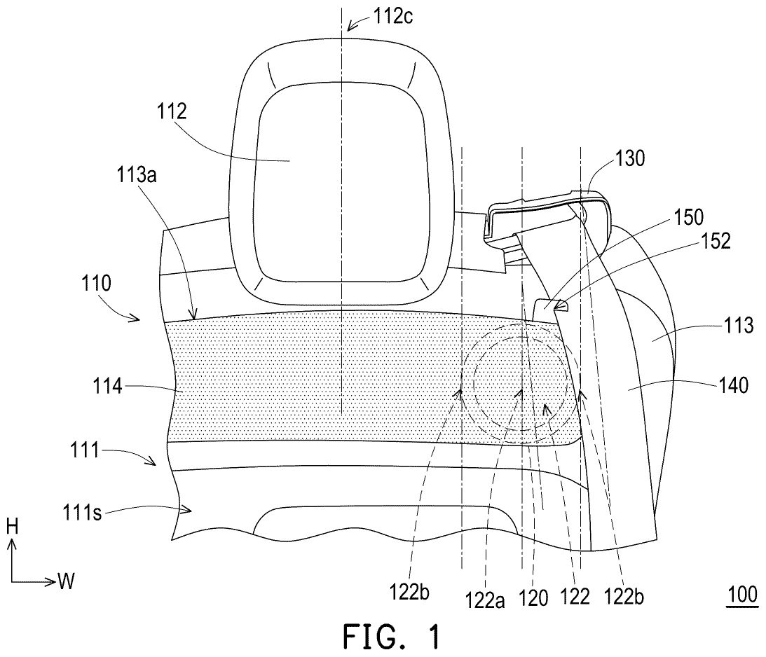

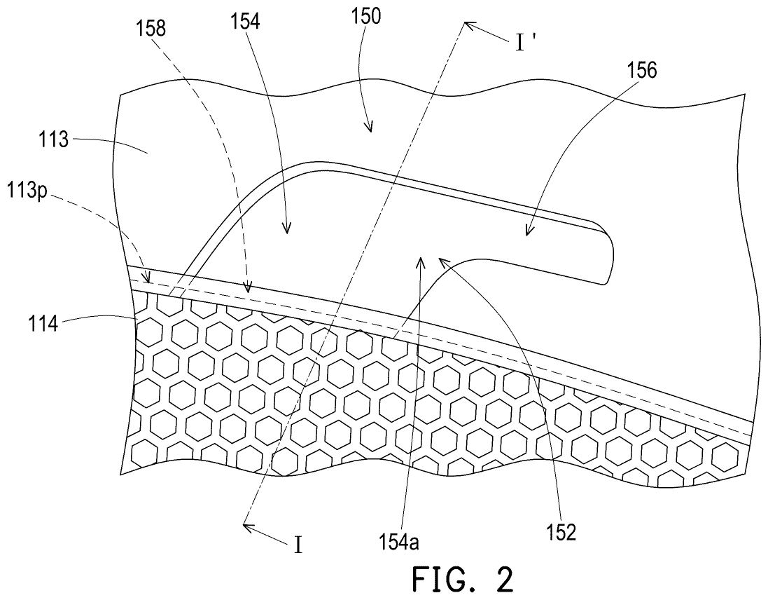

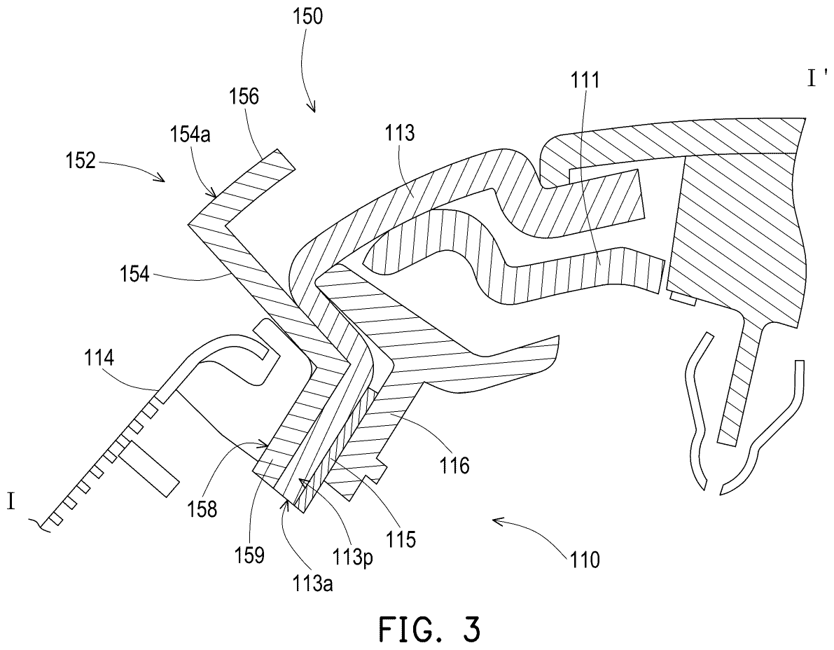

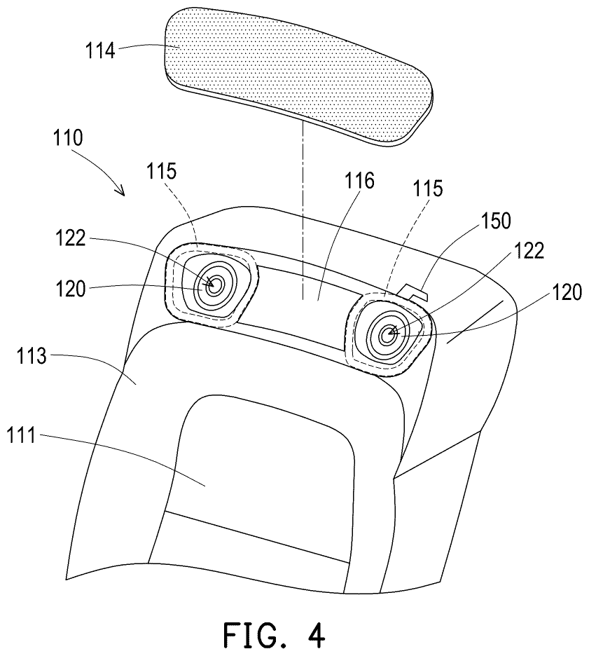

Reference will now be made in detail to exemplary embodiments of the disclosure, examples of the exemplary embodiments being illustrated in the accompanying drawings. FIG. 1 is a partial schematic view of a seat structure according to an embodiment of the disclosure. FIG. 2 is a partially enlarged schematic view around a restricting member of the seat structure shown in FIG. 1. FIG. 3 is a schematic cross-sectional view along a tangent line I-I′ around the restricting member of the seat structure shown in FIG. 2. FIG. 4 is a partial schematic view of the seat structure shown in FIG. 1 in a state in which a speaker grille is removed. Hereinafter, a specific structure of a seat structure 100 of this embodiment will be described with reference to FIGS. 1 to 4. However, this is merely one example, and the disclosure is not limited thereto, and may be adjusted as needed.

Please refer to FIG. 1. In this embodiment, a seat structure 100 includes a seat 110, a speaker 120, a webbing outlet guide 130, a seatbelt webbing 140, and a restricting member 150. The seat 110 includes a seat back 111. The speaker 120 is disposed inside the seat back 111 (a corresponding position is shown in dashed lines), and faces forward of the seat back 111. The webbing outlet guide 130 is disposed above the speaker 120, and at least a portion of the webbing outlet guide 130 overlaps a sound emitting portion 122 of the speaker 120 in a width direction W (referring to, for example, the left-right direction in FIG. 1) of the seat back 111. The seatbelt webbing 140 passes through the webbing outlet guide 130 and extends downward along a front surface 111 s of the seat back 111. The restricting member 150 is disposed on a surface of the seat back 111 (which may be a top surface, a front surface, or a surface at a boundary between the two). The restricting member 150 has a restricting portion 152 that at least restricts a position of the seatbelt webbing 140 in the width direction W, and the restricting portion 152 restricts at least a portion of the seatbelt webbing 140 from overlapping the sound emitting portion 122 of the speaker 120 in the width direction W.

Specifically, in this embodiment, as shown in FIG. 1, the seat 110 refers to a component for a passenger to sit on in a vehicle (not shown), and includes, in addition to the seat back 111, a seat cushion (not shown), so that the passenger can sit on the seat cushion and rest the back against a front surface 111 s of the seat back 111. Furthermore, the speaker 120 is built into the seat back 111 and is disposed on one side (for example, the right side in FIG. 1) in the width direction W of the seat back 111 in such a manner that a sound emitting portion 122 of the speaker 120 faces forward, so that a sound emitted from the sound emitting portion 122 of the speaker 120 can be transmitted forward and is less likely to be blocked by a passenger sitting on the seat 110. In addition, the webbing outlet guide 130 is disposed at a position higher than the speaker 120 and at least partially overlaps the sound emitting portion 122 in the width direction W, so that the seatbelt webbing 140 can be drawn out from the webbing outlet guide 130 disposed at a position in the width direction W close to the sound emitting portion 122, thereby making the use of the seatbelt webbing 140 (for example, inserting a buckle member provided at an end portion into a buckle holder beside the seat 110) easier. However, the disclosure does not limit specific structures of the seat 110, the speaker 120, and the webbing outlet guide 130, and they may be adjusted as needed.

Furthermore, in this embodiment, as shown in FIG. 1, the seatbelt webbing 140 as a seat belt main body is installed, for example, inside the seat back 111 through a retractor (not shown), and is drawn outward (forward) and downward from a drawing opening (i.e., the webbing outlet guide 130) provided on the seat back 111, so that a buckle member (not shown) provided on the drawn portion can be inserted into a buckle holder beside the seat 110 for use. Accordingly, in a case where the seatbelt webbing 140 is not in use (i.e., not inserted into a buckle member (not shown) beside the seat 110), the seatbelt webbing 140 extends downward from the webbing outlet guide 130 along the front surface 111 s of the seat back 111. However, in other embodiments not shown, the seatbelt webbing 140 may also be installed outside the seat back 111 through a retractor (not shown), and be drawn forward and downward from the webbing outlet guide 130 provided on the seat back 111. The disclosure does not limit specific structures and installation methods of the seatbelt webbing 140, as long as the seatbelt webbing 140 can extend downward along the front surface 111 s of the seat back 111 through the webbing outlet guide 130, and they may be adjusted as needed.

In addition, in this embodiment, as shown in FIG. 1, the seat structure 100 is further provided with a restricting member 150 to adjust, in a width direction W, a relative position of the seatbelt webbing 140 drawn out from the webbing outlet guide 130 with respect to a sound emitting portion 122 of the speaker 120. The restricting member 150 is, for example, a component additionally provided on a surface of the seat back 111 (which may be a top surface, a front surface, or a surface at a boundary between the two), and a restricting portion 152 of the restricting member 150 is capable of restricting a position of the seatbelt webbing 140 in the width direction W. For example, the restricting portion 152 of the restricting member 150 is located on an extending path of the seatbelt webbing 140 extending downward along a front surface 111 s of the seat back 111 from the webbing outlet guide 130 on an upper side, so that the position of the seatbelt webbing 140 in the width direction W can be restricted, for example, to cause the seatbelt webbing 140 extending downward along the front surface 111 s of the seat back 111 to shift outward in the width direction W so that at least a portion of the seatbelt webbing 140 does not overlap the sound emitting portion 122 of the speaker 120. Referring to a virtual line shown in FIG. 1 representing a position of the seatbelt webbing 140 extending downward from the webbing outlet guide 130 when the restricting member 150 is not provided, by providing the restricting member 150, even when the webbing outlet guide 130 is disposed at a position close to the sound emitting portion 122 in the width direction W, the seatbelt webbing 140 drawn out from the webbing outlet guide 130 can be restricted by the restricting member 150 such that more area of the sound emitting portion 122 is exposed. This way, the seatbelt webbing 140 can be shifted in the width direction W by the restricting portion 152 of the restricting member 150 to at least partially avoid the sound emitting portion 122 of the speaker 120.

Through the above configuration, in the seat structure 100 of this embodiment, as shown in FIG. 1, the restricting member 150 is located on a surface of the seat back 111, and therefore the restricting member 150 can be easily provided to restrict a position of the seatbelt webbing 140 without changing an original configuration of the seat structure 100. Furthermore, even when at least a portion of the webbing outlet guide 130 overlaps a sound emitting portion 122 of the speaker 120 in a width direction W such that the webbing outlet guide 130 and the speaker 120 are tightly arranged, the restricting member 150 can restrict at least a portion of the seatbelt webbing 140 from overlapping the sound emitting portion 122 of the speaker 120 in the width direction W through a restricting portion 152, thereby preventing an entire region of the seatbelt webbing 140 drawn out from the webbing outlet guide 130 from covering the sound emitting portion 122 of the speaker 120. Accordingly, the seat structure 100 is capable of improving an acoustic performance of the speaker 120 and maintaining a usability of the seatbelt webbing 140, thereby enhancing operability.

Further, in this embodiment, as shown in FIG. 1, the restricting portion 152 is, in the width direction W, located between a central portion 122a and a peripheral portion 122b of the sound emitting portion 122. Here, as an example, the restricting portion 152 is located in the width direction W between the central portion 122a and a peripheral portion 122b close to an outer side (for example, a right side in the drawing), but in other embodiments not shown, the restricting portion 152 may also be located in the width direction W between the central portion 122a and a peripheral portion 122b close to an inner side, that is, a center side (for example, a left side in the drawing). This way, the seatbelt webbing 140 drawn out from the webbing outlet guide 130 and restricted by the restricting member 150 is located, in the width direction W, farther toward the outer side than the central portion 122a of the sound emitting portion 122 (for example, the right side in the drawing), so that at least more than half of the sound emitting portion 122 (for example, a left side portion in the drawing) is not covered by the seatbelt webbing 140. That is, the restricting portion 152 can restrict the seatbelt webbing 140 from overlapping at least more than half of the sound emitting portion 122 of the speaker 120 in the width direction W. Through the above configuration, the seatbelt webbing 140 can be maintained, after being restricted by the restricting member 150, at a position easy to avoid the speaker 120 (i.e., without specifically setting the seatbelt webbing 140 at a position far from the speaker 120), and distortion caused by drawing out the seatbelt webbing 140 from a distant location and abrasion generated at a portion of the seatbelt webbing 140 at the webbing outlet guide 130 can be suppressed. Accordingly, the seat structure 100 is capable of further improving an acoustic performance of the speaker 120 and maintaining a usability of the seatbelt webbing 140, thereby enhancing operability.

Furthermore, in this embodiment, as shown in FIG. 1, the restricting portion 152 is located between the sound emitting portion 122 and the webbing outlet guide 130. As an example, the restricting portion 152 is located in the width direction W between the sound emitting portion 122 and the webbing outlet guide 130, and is located in an up-down direction H between the sound emitting portion 122 and the webbing outlet guide 130. This way, the seatbelt webbing 140 drawn out from the webbing outlet guide 130 and restricted by the restricting member 150 can be drawn out in a most appropriate manner (for example, a short size of the drawn-out portion, no significant bending of the drawn-out portion, and so on) and extend downward along a front surface 111 s of the seat back 111. Through the above configuration, the seatbelt webbing 140 can be maintained, after being restricted by the restricting member 150, at a position easy to avoid the speaker 120 (i.e., without specifically disposing the seatbelt webbing 140 at a position far from the speaker 120), and distortion caused by drawing out the seatbelt webbing 140 from a distant location and abrasion generated at a portion of the seatbelt webbing 140 at the webbing outlet guide 130 can be suppressed. Accordingly, the seat structure 100 is capable of further improving an acoustic performance of the speaker 120 and maintaining a usability of the seatbelt webbing 140, thereby enhancing operability.

In addition, in this embodiment, as shown in FIG. 1, the seat 110 further includes a headrest 112 disposed on the seat back 111. The speaker 120 and the webbing outlet guide 130 are, in a width direction W, located on at least one side (for example, a right side in the drawing) relative to a center 112c of the headrest 112 (as shown by a dashed line), and the restricting portion 152 is located in the width direction W at a position farther from the center 112c of the headrest 112 than a central portion 122a of the sound emitting portion 122 (for example, a right side of the center 112c in the drawing). This way, when a passenger sits on a seat cushion (not shown) of the seat 110 and rests the back against a front surface 111 s of the seat back 111, the passenger can rest the head against a front surface of the headrest 112 (but this is not limiting). In addition, the speaker 120 and the webbing outlet guide 130 are located in the width direction W on one side (for example, the right side in the drawing) relative to the center 112c of the headrest 112, and the restricting portion 152 restricts the seatbelt webbing 140 at a position farther from the center 112c of the headrest 112 than the central portion 122a of the sound emitting portion 122 (for example, the right side of the center 112c in the drawing). This way, the seatbelt webbing 140 can not only avoid the sound emitting portion 122, but also extend downward along the front surface 111s at a position farther outward relative to a center of the seat 110 (corresponding to the center 112c of the headrest 112). Therefore, compared to a case where the restricting portion 152 is located in the width direction W between the central portion 122a of the sound emitting portion 122 and an inner side, that is, a center side (for example, a left side in the drawing), the passenger can more easily grab the seatbelt webbing 140 located on the outer side when using the seatbelt (the seatbelt webbing 140 will not be blocked by the passenger), thereby increasing a usability of the seatbelt webbing 140.

Furthermore, in this embodiment, as shown in FIGS. 2 and 3, the restricting member 150 has flexibility and is made of, for example, a rubber material. The restricting member 150 includes a base portion 154 and an extended portion 156. The base portion 154 extends (that is, protrudes) forward and upward along a surface of the seat back 111 (which may be a top surface, a front surface, or a surface at a boundary between the two). The extended portion 156 extends from an upper end of the base portion 154 outward in the width direction W (for example, a right side in the drawing) relative to a central portion 122a of the sound emitting portion 122, and the restricting portion 152 is formed by an end portion 154a of the base portion 154 corresponding to the extended portion 156 (that is, a boundary between the base portion 154 and the extended portion 156). However, in other embodiments not shown, in a case where the restricting portion 152 is located in the width direction W between the central portion 122a and a peripheral portion 122b close to an inner side, that is, a center side (for example, a left side in the drawing), the extended portion 156 of the restricting member 150 extends from the upper end of the base portion 154 inward in the width direction W (for example, a left side in the drawing) relative to the central portion 122a of the sound emitting portion 122. Accordingly, it is understood that as long as the extended portion 156 extends in a direction farther away from the central portion 122a of the sound emitting portion 122 than the base portion 154, it is acceptable. The disclosure does not limit a specific structure of the restricting member 150, and it may be adjusted as needed.

Through the above configuration, in this embodiment, as shown in FIGS. 2 and 3, since the restricting member 150 has flexibility, even when the restricting member 150 protrudes from the seat back 111, the passenger will not be harmed. In addition, even when the passenger pulls the seatbelt webbing 140, damage to the flexible restricting member 150 and abrasion generated at a portion of the seatbelt webbing 140 at the restricting member 150 can be suppressed. Furthermore, the restricting member 150 uses the end portion 154a of the base portion 154 corresponding to the extended portion 156 as the restricting portion 152, and therefore, in a case where the restricting member 150 holds the seatbelt webbing 140 and receives a load from the seatbelt webbing 140 (for example, a force applied when the passenger pulls the seatbelt webbing 140), the load from the seatbelt webbing 140 is transmitted toward the base portion 154 in a shearing direction of the base portion 154, so the restricting member 150 is not easily damaged by the force. In addition, the restricting member 150 can sandwich the seatbelt webbing 140 between the restricting portion 152 (the end portion 154a), the extended portion 156, and the surface of the seat back 111, and therefore a protruding amount of the restricting member 150 from the surface of the seat back 111 can be suppressed. Moreover, even when the flexible restricting member 150 is used, the seatbelt webbing 140 can be firmly held through the above-mentioned sandwiching. Accordingly, the seat structure 100 is capable of further improving a usability of the seatbelt webbing 140.

In addition, in this embodiment, as shown in FIGS. 1 to 3, the seat 110 further includes a skin member 113 that covers the seat back 111 and forms the surface (which may be a top surface, a front surface, or a surface at a boundary between the two), and a speaker grille 114 that covers the speaker 120 from a front side of the skin member 113. The restricting member 150 has a stitched portion 158 stitched to the skin member 113, and the stitched portion 158 is located at a portion (referred to here as a grille covering portion 113p) of the skin member 113 covered by the speaker grille 114. That is, the skin member 113 covering the seat back 111 has the grille covering portion 113p, and the speaker grille 114 is mounted in front of the speaker 120 and at least partially covers the grille covering portion 113p. Therefore, a sound emitted from the sound emitting portion 122 of the speaker 120 can be transmitted to the outside (a front side) through the speaker grille 114. The restricting member 150 is fixed to the grille covering portion 113p of the skin member 113 by stitching and is covered by the speaker grille 114, so that the restricting member 150 can be firmly fixed by the stitched portion 158 being sandwiched between the skin member 113 and the speaker grille 114, and the stitched portion 158 can be hidden between the speaker grille 114 and the grille covering portion 113p of the skin member 113 and has good appearance quality. In addition, in a case where the restricting portion 152 is located between the sound emitting portion 122 and the webbing outlet guide 130, the restricting portion 152 is further disposed above the speaker 120 and at a position close to the sound emitting portion 122, so that the seatbelt webbing 140 can effectively avoid the sound emitting portion 122 without having to be specifically set at a position far from the speaker 120, thereby improving an acoustic performance of the speaker 120, and at the same time, distortion caused by drawing out the seatbelt webbing 140 from a distant location can be suppressed, thereby improving a usability of the seatbelt webbing 140.

Furthermore, in this embodiment, as shown in FIGS. 2 and 3, the restricting member 150 has a flange portion 159 extending along the skin member 113, and the stitched portion 158 is disposed on the flange portion 159. As an example, the restricting member 150 is formed by the extended portion 156, the base portion 154, and the flange portion 159 being bent with respect to one another into a structure having a generally Z-shaped cross section (as shown in FIG. 3), wherein an end portion 154a of the base portion 154 corresponding to the extended portion 156 forms the restricting portion 152, and the flange portion 159 forms the stitched portion 158. Therefore, the restricting member 150 can be stitched at the flange portion 159 (forming the stitched portion 158) so that the flange portion 159 extends along the skin member 113 and is fixed to the skin member 113, and the flange portion 159 (forming the stitched portion 158) can be easily sandwiched between the skin member 113 and the speaker grille 114 and be firmly fixed. In addition, the restricting portion 152 (the end portion 154a of the base portion 154 corresponding to the extended portion 156) used to hold the seatbelt webbing 140 extends from the firmly fixed flange portion 159, and therefore, even when the flexible restricting member 150 is used, the seatbelt webbing 140 can be firmly held through the above-described sandwiching. However, the disclosure does not limit a specific structure of the restricting member 150, and it may be adjusted as needed.

Furthermore, in this embodiment, as shown in FIGS. 3 and 4, the skin member 113 has an opening portion 113a located at a portion facing the sound emitting portion 122, and the seat 110 further includes a reinforcing member 115 located at a periphery of the opening portion 113a and fixed to the skin member 113. As an example, in a case where two speakers 120 are provided on the seat back 111 (as shown in FIG. 4), the skin member 113 may be provided with a single opening portion 113a corresponding to two sound emitting portions 122 (as shown in FIG. 4), or may be provided with two opening portions respectively corresponding to the two sound emitting portions 122 (not shown). The sound emitting portion 122 is exposed through the opening portion 113a of the skin member 113, and an edge of the opening portion 113a forms the aforementioned grille covering portion 113p. The speaker grille 114 is disposed in front of the opening portion 113a and at least partially covers the grille covering portion 113p. In addition, the reinforcing member 115 is, for example, a reinforcing frame extending along a contour of the opening portion 113a (corresponding to the grille covering portion 113p). This way, the provision of the opening portion 113a can prevent the skin member 113 from covering the sound emitting portion 122 from a front side and affecting an acoustic performance of the speaker 120, and the provision of the reinforcing member 115 can suppress deformation or damage of the skin member 113 between the opening portion 113a and the grille covering portion 113p. However, the disclosure does not limit a specific structure of the reinforcing member 115 or whether it is provided, and it may be adjusted as needed.

In addition, in this embodiment, as shown in FIGS. 3 and 4, the restricting member 150 and the reinforcing member 115 are stitched together to the skin member 113. As an example, the reinforcing member 115 is disposed on an inner surface of a grille covering portion 113p of the skin member 113, and a flange portion 159 of the restricting member 150 is disposed on an outer surface of the grille covering portion 113p of the skin member 113. In a case where the flange portion 159 of the restricting member 150 is stitched to the skin member 113, the reinforcing member 115 is further stitched to the grille covering portion 113p of the skin member 113 (corresponding to the opening portion 113a). More specifically, the flange portion 159 of the restricting member 150, the grille covering portion 113p of the skin member 113, and the reinforcing member 115 are stitched together in sequence from outside to inside. This way, by firmly fixing the restricting member 150 and the reinforcing member 115 together to the skin member 113, a structural strength of the restricting member 150 can be increased so that the restricting member 150 can more reliably restrict a position of the seatbelt webbing 140. In other embodiments not shown, the reinforcing member 115 may also be disposed on an outer surface of the grille covering portion 113p of the skin member 113, so that the flange portion 159 of the restricting member 150, the reinforcing member 115, and the grille covering portion 113p of the skin member 113 are stitched together in sequence from outside to inside. Alternatively, the flange portion 159 of the restricting member 150 and the reinforcing member 115 may also be stitched separately or installed in other ways at a periphery of the opening portion 113a of the skin member 113. The disclosure does not limit a fixing method and fixing order of the restricting member 150 and the reinforcing member 115, and they may be adjusted as needed.

Furthermore, in this embodiment, as shown in FIGS. 3 and 4, the seat 110 further includes an interior decorative member 116 fixed to the seat back 111 and disposed closer to an inner side of the seat back 111 than to the skin member 113, and the stitched portion 158 is located between the speaker grille 114 and the interior decorative member 116. As an example, the interior decorative member 116 is disposed on an inner side of the speaker grille 114, surrounds the speaker 120, and corresponds to an inner surface of the grille covering portion 113p of the skin member 113. This way, in a case where the flange portion 159 (forming the stitched portion 158) of the restricting member 150 is stitched to the grille covering portion 113p of the skin member 113, the stitched portion 158 (the flange portion 159) corresponds to the speaker grille 114 on an outer side and the interior decorative member 116 on an inner side, and is sandwiched by the speaker grille 114 and the interior decorative member 116, and is supported from the outer side and the inner side by the speaker grille 114 and the interior decorative member 116. This way, the restricting member 150 is firmly fixed by being sandwiched by the speaker grille 114 and the interior decorative member 116 having higher structural strength, and a structural strength of the restricting member 150 can be improved so that the restricting member 150 can more reliably restrict a position of the seatbelt webbing 140. However, the disclosure does not limit a specific structure of the interior decorative member 116 or whether it is provided, and it may be adjusted as needed.

In summary, in the seat structure of the disclosure, the restricting member is located on a surface of the seat back, and therefore the restricting member can be easily provided to restrict a position of the seatbelt webbing without changing an original configuration of the seat structure. Furthermore, even when at least a portion of the webbing outlet guide overlaps a sound emitting portion of the speaker in the width direction so that the webbing outlet guide and the speaker are tightly arranged, the restricting member can restrict at least a portion of the seatbelt webbing from overlapping the sound emitting portion of the speaker in the width direction through the restricting portion, thereby preventing an entire region of the seatbelt webbing drawn out from the webbing outlet guide from covering the sound emitting portion of the speaker. Preferably, the restricting portion is located in the width direction between a central portion and a peripheral portion of the sound emitting portion, and is located between the sound emitting portion and the webbing outlet guide, so that the seatbelt webbing can be maintained at a position easy to avoid the speaker, and distortion caused by drawing out the seatbelt webbing from a distant location and abrasion generated at a portion of the seatbelt webbing at the webbing outlet guide can be suppressed. Accordingly, the seat structure of the disclosure is capable of improving an acoustic performance of the speaker and maintaining a usability of the seatbelt webbing, thereby enhancing operability.

Finally, it should be noted that the above embodiments are only used to illustrate the technical solutions of the disclosure and are not intended to limit the disclosure. Although the disclosure has been described in detail with reference to the foregoing embodiments, those skilled in the art should understand that modifications may still be made to the technical solutions described in the foregoing embodiments, or some or all of the technical features may be replaced with equivalents. These modifications or replacements do not cause the essence of the corresponding technical solutions to deviate from the scope of the technical solutions in the embodiments of the disclosure.

What is claimed is:

1. A seat structure, comprising:
a seat, comprising a seat back;
a speaker, disposed inside the seat back and facing forward of the seat back;
a webbing outlet guide, disposed above the speaker and at least partially overlapping a sound emitting portion of the speaker in a width direction of the seat back;
a seatbelt webbing, passing through the webbing outlet guide and extending downward along a front surface of the seat back; and
a restricting member, disposed on a surface of the seat back, wherein the restricting member has a restricting portion that at least restricts a position of the seatbelt webbing in the width direction, and
the restricting portion restricts at least a portion of the seatbelt webbing from overlapping the sound emitting portion of the speaker in the width direction.

2. The seat structure according to claim 1, wherein
the restricting portion is, in the width direction, located between a central portion and a peripheral portion of the sound emitting portion.

3. The seat structure according to claim 1, wherein
the restricting portion is located between the sound emitting portion and the webbing outlet guide.

4. The seat structure according to claim 1, wherein
the seat further comprises a headrest disposed on the seat back,
the speaker and the webbing outlet guide are, in the width direction, located on at least one side relative to a center of the headrest, and
the restricting portion is, in the width direction, located at a position farther from the center of the headrest than a central portion of the sound emitting portion.

5. The seat structure according to claim 1, wherein
the restricting member has a flexibility and comprises:
a base portion, extending forward and upward along the surface of the seat back; and
an extended portion, extending from an upper end of the base portion outward in the width direction relative to a central portion of the sound emitting portion, and
the restricting portion is formed by an end portion of the base portion corresponding to the extended portion.

6. The seat structure according to claim 1, wherein
the seat further comprises a skin member that forms the surface by covering the seat back, and a speaker grille that covers the speaker from a front side of the skin member,
the restricting member has a stitched portion stitched to the skin member, and
the stitched portion is located at a portion of the skin member covered by the speaker grille.

7. The seat structure according to claim 6, wherein
the restricting member has a flange portion extending along the skin member, and
the stitched portion is disposed on the flange portion.

8. The seat structure according to claim 6, wherein
the skin member has an opening portion located at a portion facing the sound emitting portion,
the seat further comprises a reinforcing member located at a periphery of the opening portion and fixed to the skin member, and
the restricting member and the reinforcing member are stitched together to the skin member.

9. The seat structure according to claim 6, wherein
the seat further comprises an interior decorative member fixed to the seat back and disposed closer to an inner side closer of the seat back than to the skin member, and
the stitched portion is located between the speaker grille and the interior decorative member.
